(19) United States
(12) Patent Application Publication
(10) Pub. No.: US 2004/0032034 A1
(43) Pub. Date: Feb. 19, 2004

(54) Ultraviolet (UV) oven with segmented reflectors

(75) Inventor: Ajit Bhat, Alpharetta, GA (US)

Correspondence Address: GARDNER GROFF, P.C., PAPER MILL VILLAGE, BUILDING 23, 600 VILLAGE TRACE, SUITE 300, MARIETTA, GA, 30067, US

(73) Assignee: Fitel USA Corp., Norcross, GA (US)

(21) Appl. No.: 10/218,260

(22) Filed: Aug. 14, 2002

(51) Int. Cl. B29D 11/00; B29C 35/10

(52) U.S. Cl. 264/1.27; 264/495; 425/174.4

(57) ABSTRACT

The present invention provides a curing oven for curing a material disposed on an object, such as an optical fiber ribbon, for example, disposed in the oven. The curing oven comprises a radiation source for emitting curing radiation and at least a first reflector that reflects curing radiation emitted by radiation source onto the object. The first reflector comprises a plurality of flat reflective segments that are arranged in a curved configuration. The arrangement of the reflective segments causes the radiation reflected by the reflector onto the object to be substantially uniformly distributed over at least a portion of the object, which results in better, more uniform curing of the exposed curing material, as well as other advantages.

### TECHNICAL FIELD OF THE INVENTION

The present invention relates to ultraviolet (UV) curing ovens and, more particularly, to a UV curing oven that provides uniform intensity distribution of UV radiation over the surface of a substantially planar object, such as an optical fiber ribbon, for example.

### BACKGROUND OF THE INVENTION

The quality of manufactured optical fiber ribbons is largely dependent on the quality of the curing process. When an optical fiber ribbon is manufactured, the optical fibers that form the optical fiber ribbon are typically pulled through a die where a combination of optical fibers are coated with a liquid polymeric matrix material. This is shown in FIG. 1, which generally depicts a known process for creating an optical fiber ribbon. An optical fiber ribbon typically comprises 4, 8, 12, 16 or 24 optical fibers that are held together by a cured polymeric matrix material.

In the example shown in FIG. 1, the optical fiber ribbon has six optical fibers. The manufacturing line 1 comprises six payoff rolls 2, each of which typically holds a large length of optical fiber 3. As the optical fibers 3 are fed out from the payoff rolls 2, they are pulled though a die 4 that positions the optical fibers adjacent one another as it coats the fibers with the liquid polymeric matrix material. The coated combination of optical fibers is then pulled through a UV curing oven 5 where the combination is exposed to UV radiation. Exposure to the UV radiation causes the polymeric matrix material to solidify or harden. The hardened polymeric matrix material holds the optical fibers together in the ribbon configuration. A take up roll 6 takes up the ribbon 7 after curing.

Over-curing of the polymeric matrix material results in a hardened coating that is very difficult if not impossible to strip. On the other hand, under-curing of the polymeric matrix material leaves a soft coating that is tacky and that might not provide adequate protection to the fiber. FIG. 2 is a block diagram of a side view of a known UV curing oven that is used to cure the polymeric matrix material coated on an optical fiber ribbon. The UV curing oven 10 comprises a primary reflector 11, a secondary reflector 12, a UV-emitting bulb 13 and a quartz tube 14. The vertical line 15 inside of the quartz tube 14 represents an end view of an optical fiber ribbon being pulled through the UV curing oven 10. UV rays (not shown) generated by the bulb 13 that impinge directly on the ribbon 15 or on the primary and/or secondary reflectors 11 and/or 12. Most of the UV rays that impinge on the reflectors 11 and 12 are reflected by the reflectors 11 and 12, pass through the quartz tube 14, which is transparent, and impinge on the ribbon 15, thereby causing the polymeric matrix material to cure.

For various reasons, the geometry of the UV curing oven shown in FIG. 2 results in non-uniform intensity over the width of the optical fiber ribbon 15. Generally, the majority of the UW radiation generated by bulb 13 is focused by the primary and secondary reflectors 11 and 12 at the center of the optical fiber ribbon 15. To compensate for this non-uniformity in intensity over the width of the optical fiber ribbon 15, typically a very high intensity is used so that the polymeric matrix material is cured before the non-uniformity in intensity results in bending or bowing of the ribbon 15.

However, requirements for materials and products are becoming more stringent, resulting in a need to closely control the UV intensity used and/or the uniformity of the UV intensity distribution across the width of the target. Accordingly, a need exists for a UV curing oven that is capable of providing uniform UV radiation intensity over the entire width of a substantially planar object (i.e., the target), such as an optical fiber ribbon, for example, to cure the polymeric matrix material on the object.

### SUMMARY OF THE INVENTION

The present invention provides a curing oven for curing a material disposed on an object, such as an optical fiber ribbon, for example, in the oven. The curing oven comprises a radiation source for emitting curing radiation and at least one reflector that reflects curing radiation emitted by the radiation source onto the object. This reflector comprises a plurality of substantially flat reflective segments arranged in a curved configuration to form a reflective surface. The arrangement of the reflective segments causes the radiation reflected by the first reflector onto the object to be substantially uniformly distributed over the width of the object, which results in better, more uniform curing of the curing material, as well as other advantages.

The present invention also provides the reflector for the curing oven, which comprises a plurality of substantially flat reflective segments arranged in a curved configuration to form a reflective surface. As indicated above, the arrangement of the reflective segments causes the curing radiation emitted by the radiation source, and reflected by the reflective surface onto the object, to be substantially uniformly distributed over the width of the object. This results in the curable material on the object being substantially uniformly cured on the object.

The present invention also provides a method for curing a curable material that has been placed on an object disposed in a curing oven. The method comprises the steps of emitting curing radiation from a radiation source and providing a first reflector comprised of a plurality of substantially flat reflective segments that reflects curing radiation emitted by the radiation source onto the object. As indicated above, the substantially flat reflective segments are arranged in a curved configuration, e.g., elliptically arranged. The arrangement of the reflective segments of the reflector causes the curing radiation reflected by the reflector onto the object to be substantially uniformly distributed over the width of the object so that the curable material on the object is substantially uniformly cured.

These and other features and advantages of the present invention will become apparent from the following description, drawings and claims.

### BRIEF DESCRIPTION OF THE DRAWINGS

FIG. 1 is a block diagram of an example of an optical fiber ribbon manufacturing line.

FIG. 2 is a block diagram side view of an example of a known UV curing oven for curing the liquid polymeric matrix material placed on the optical fibers of the ribbon during the manufacturing process.

FIG. 3 is a graph illustrating the intensity of UV radiation provided by the known oven shown in FIG. 2 over the width of the optical fiber ribbon.

FIG. 4 is a plan view of a portion of an 8-fiber ribbon.

FIG. 5 is a side view of the UV curing oven of the present invention in accordance with an example embodiment, which comprises a segmented secondary reflector that ensures uniform UV radiation intensity over the width of a substantially planar object, such as an optical fiber ribbon, for example.

FIG. 6 is an enlarged side view of the segmented secondary reflector shown in FIG. 5.

FIG. 7 is a flow chart illustrating the method of the present invention in accordance with an example embodiment.

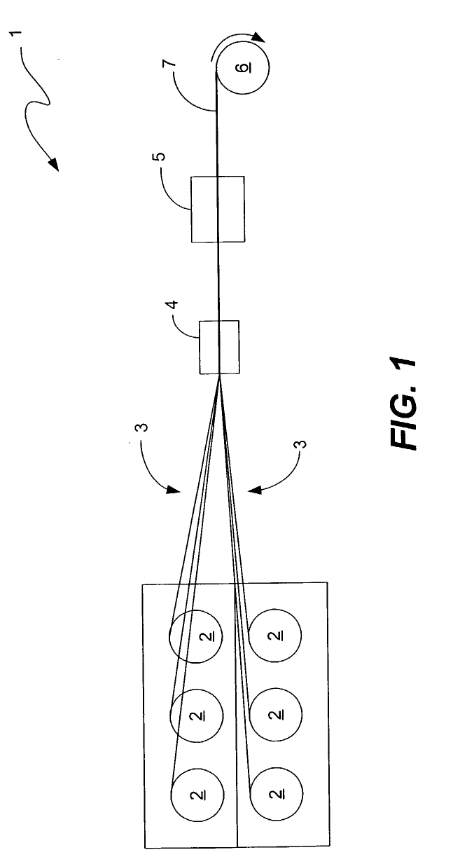

### DETAILED DESCRIPTION OF THE PREFERRED EMBODIMENTS

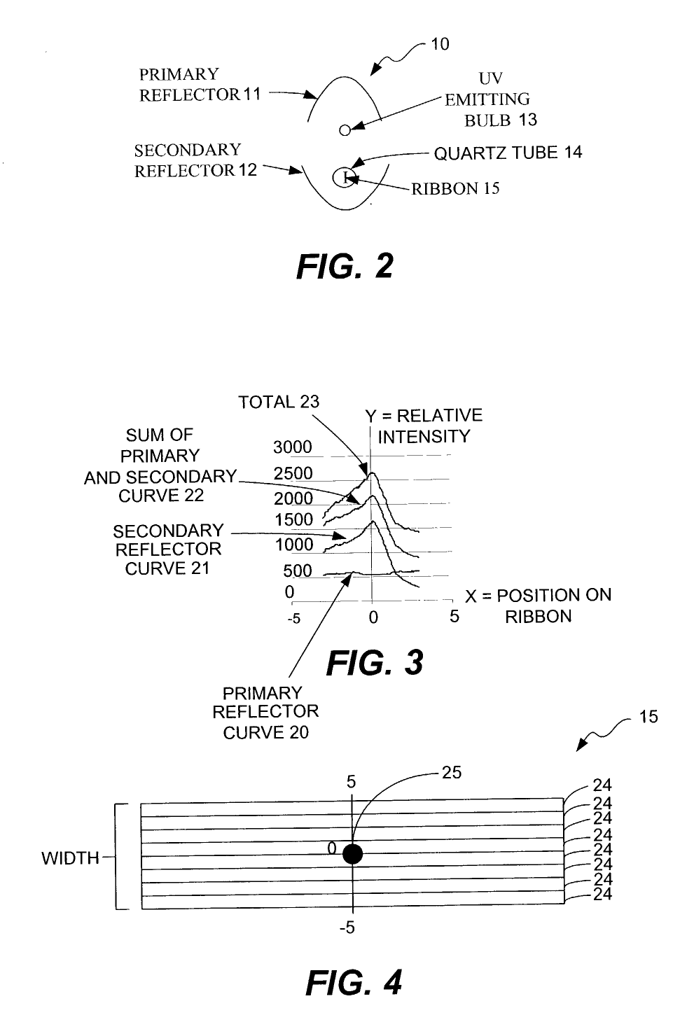

FIG. 3 is a graph illustrating the intensity of UV radiation provided by the known oven 10 shown in FIG. 2 over the width of the optical fiber ribbon 15, which, in this example, is an 8-fiber ribbon. The X-axis corresponds to the position at which intensity is focused along the width of the ribbon 15. FIG. 4 is a plan view of a portion of the 8-fiber ribbon 15. The line 26 drawn across the width of the ribbon 15 in FIG. 4 corresponds to the X-axis in the graph of FIG. 3. The number 0 on the X-axis of FIG. 3 corresponds to the center region 25 of the ribbon 15 shown in FIG. 4. The number 5 at one end of the X-axis in the graph of FIG. 3 corresponds to the 5 at the top end of the line 26 in FIG. 4. The number −5 on the X-axis of FIG. 3 corresponds to the −5 at the bottom end of the line 26 in FIG. 4. As stated above, the known UV oven 10 shown in FIG. 2 focuses the majority of the UV radiation at the center region 25 (FIG. 4) of the ribbon 15.

The graph of FIG. 3 shows four different UV relative radiation intensity curves, each of which indicates the manner in which a component or combination of components of the UV curing oven 10 (FIG. 2) distributes UV radiation over the width of the optical fiber ribbon 15, as well as the relative intensity of the radiation distributed at locations over the width of the ribbon 15. The primary reflector curve 20, which corresponds to the primary reflector 11 (FIG. 2), is relatively flat, which indicates that the UV radiation reflected by the primary reflector 11 is relatively uniformly distributed over the width of the ribbon 15. The fact that the primary reflector curve 20 is the lowest on the Y-axis indicates that the least amount of radiation that impinges on the ribbon 15 comes from the primary reflector 11.

The secondary reflector curve 21, which corresponds to radiation reflected over the width of the ribbon 15 by the secondary reflector 12, has a peak on the Y-axis, which indicates that the majority of the UV radiation reflected by the secondary reflector 12 onto the ribbon 15 is focused at the center (x=0) of the ribbon 15. The region 25 shown in FIG. 4 corresponds to this peak. The sum curve 22 corresponds to the sum of the radiation reflected by the primary and secondary reflectors 11 and 12, respectively, onto the ribbon 15. The intensity is higher for curve 22 than for curves 20 and 21 and the curve 22 has a peak at x=0 (region 25 in FIG. 4), which indicates that the majority of the radiation reflected by both reflectors 11 and 12 that impinges on the ribbon 15 is focused at the center region 25 of the ribbon 15.

The curve 23 corresponds to the total radiation from the bulb 14 and from the reflectors 11 and 12 (including multiple reflections) that impinges on the ribbon 15. Curve 23 also corresponds to the highest relative intensity in the graph of FIG. 3 and has a peak on the Y-axis (x=0), which means that the total amount of radiation that impinges on the ribbon 15 is focused primarily at the center region 25 (FIG. 4) of the ribbon 15.

The known UV curing oven 10 of FIG. 2 works for its intended purpose without resulting in bowing or bending of the ribbon 15 due to the fact that the intensity of the UV radiation produced by the bulb 14 and reflected by the primary and secondary reflectors 11 and 12 onto the ribbon 15 is relatively high. In other words, the intensity of the UV radiation to which the ribbon 15 is exposed is sufficiently high that the ribbon 15 is cured before it has an opportunity to bow or bend. The relatively low speed of the ribbon manufacturing line also assists in the ribbon 15 being sufficiently exposed as it passes through the oven 10.

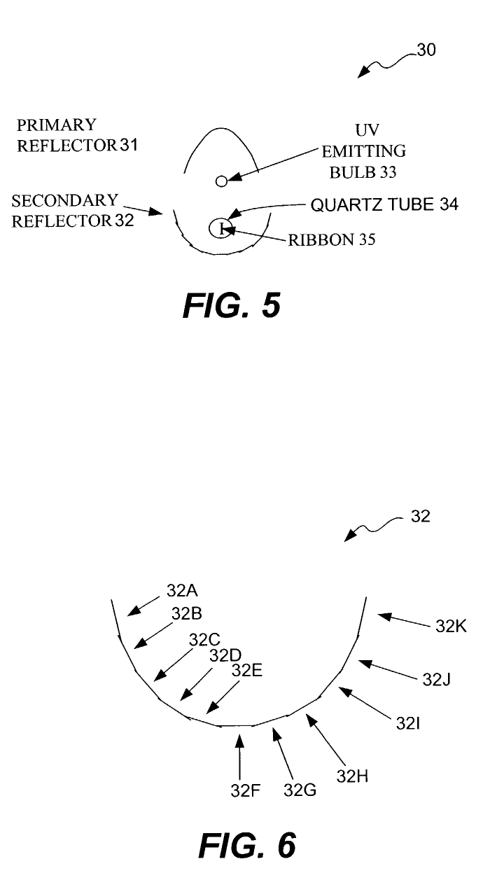

In accordance with the present invention, the geometry of the UV oven (FIG. 5) is such that the optical fiber ribbon is substantially uniformly exposed over its width to the UV radiation, thereby obviating the need to apply high intensity UV radiation to the ribbon. This, in turn, results in a longer life span for the UV-emitting bulb, which results in less maintenance for the UV curing oven. Also, although the line speed is generally limited by factors other than providing increased exposure time for ribbon as it passes through the UV curing oven, uniformly exposing the ribbon to the UV radiation in accordance with the present invention could potentially result in faster curing time, which could potentially enable the line speed to be increased (provided other limitations on the line speed are eliminated).

In accordance with the preferred embodiment of the present invention, the primary reflector and/or the secondary reflector is segmented to cause the radiation to be uniformly distributed across the width of the optical fiber ribbon. FIG. 5 is a block diagram side view of the UV oven 30 of the present invention in accordance with an example embodiment. The oven 30 of the present invention comprises a primary reflector 31, a secondary reflector 32, a UV-emitting bulb 33 and a quartz tube 34, through which the ribbon 35 passes as it passes through the oven. Also, in this example embodiment, the positions of the components 31-34 of the oven 30 relative to each other are generally the same as the relative positions of the components of the oven 10 of FIG. 2.

However, unlike the oven 10 shown in FIG. 2, the oven 30 of the present invention comprises a segmented primary 31 and/or secondary reflector 32. For example purposes, only the secondary reflector 32 is shown as being comprised of a plurality of reflective segments. It should be noted that the primary reflector 31 rather than the secondary reflector 32 could be comprised of a plurality of reflective segments. Alternatively, both the primary reflector 31 and the secondary reflector 32 may be comprised of segmented reflectors. In all three cases, the UV radiation will be more uniformly distributed over the width of the ribbon 35 than with the known UV curing oven shown in FIG. 2.

In accordance with the present invention, experimentation has proven that if the parabolic, or elliptical, surfaces of the primary and/or secondary reflectors 31 and 32 are replaced with a plurality of flat, reflector segments, the UV radiation from the bulb 33 will not converge to a small region at the center of the ribbon 35, but instead will be uniformly distributed over a larger region of the ribbon 35 as the ribbon 35 is pulled through the UV curing oven 30. This enables substantially uniform curing of the ribbon 35 with less intensity (if desired) and also makes the UV curing process less sensitive to the position of the ribbon 35 within the quartz tube 34. Although reflectors have in the past been made up of a plurality of reflective parts, such reflectors were not used in UV curing ovens and were so constructed only for ease of construction, i.e., not to provide more uniform distribution of radiation over a target. This is because, in general, flat surfaces are more easily constructed than curved surfaces.

Also, radiation distribution uniformity becomes even more critical as the target becomes larger. For example, uniformity in the UV radiation distribution when performing the curing process for a 24-fiber ribbon is more critical than when performing the curing process for a 4-fiber ribbon. Also, if the curing properties of matrix materials used in the future become more sensitive to radiation intensity, it may become necessary to use lower intensity. In this case, a uniform distribution of radiation may become essential.

FIG. 6 is an enlarged view of the secondary reflector 32 shown in FIG. 5. As shown in FIG. 6, the parabolic or elliptical shape of the reflector 32 is comprised of a plurality of flat reflector segments 32A-32K. The primary reflector 31 shown in FIG. 5 could be similarly constructed. It should be noted that the number of reflective segments used to construct the primary or secondary reflectors 31 or 32 is not limited to any particular number. However, for optimum results, the widths of the segments should be chosen taking the width of the ribbon (or other substantially flat surface) into account. For example, the reflective segments should be wider for curing a 24-fiber ribbon than for curing a 4-fiber ribbon. The widths chosen for the reflective segments also depend on the geometry of the curing oven in which the primary 31 and/or secondary reflectors 32 comprising the reflective segments are utilized. Those skilled in the art will understand, in view of the discussion provided herein, how to choose the widths of the reflective segments to obtain the desired results.

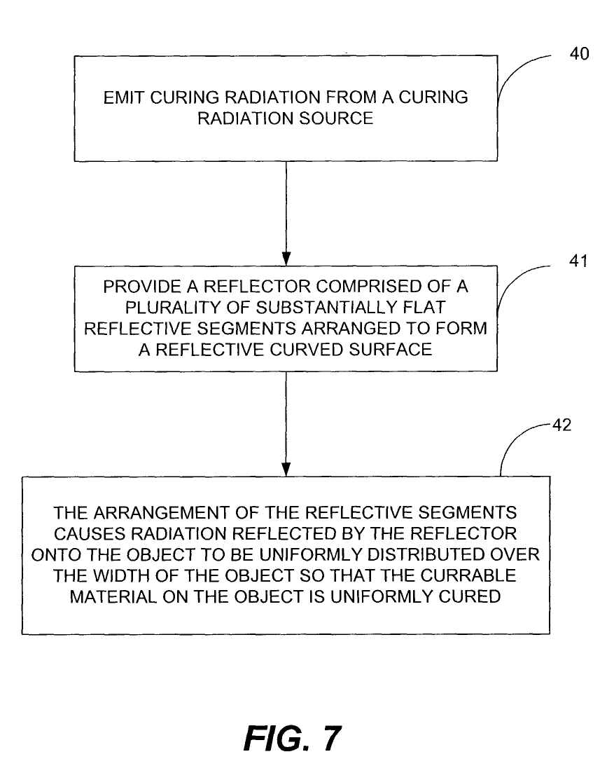

FIG. 7 is a flow chart that represents the method of the present invention in accordance with an embodiment. The method includes the step of emitting radiation from a curing radiation source, as indicated by block 40. The method also comprises the step of providing the reflector of the present invention, which comprises a plurality of flat reflective segments arranged in a curved configuration to form a reflective surface, as indicated by block 41. The arrangement of the reflective segments is such that radiation emitted by the radiation source that is reflected by the reflector is distributed over the width of the object substantially uniformly such that the curable material on the object is substantially uniformly cured. This step is represented by block 42. The method could further include providing a second reflector configured in the same manner to provide uniform distribution of reflected radiation (not shown).

It should be noted that the above-described embodiments of the present invention are examples of implementations. For example, the present invention is not limited to the geometry of the UV oven of FIG. 5, or to any particular geometry for the UV curing oven. The present invention also is not limited to materials cured by exposure to UV radiation. Furthermore, although the primary and secondary reflectors 31 and 32, respectively, are shown as being parabolic or elliptical in shape, other shapes are possible. The term “curved” is used herein to define shapes that are semi-circular, parabolic or elliptical, as well as other shapes. Those skilled in the art will understand from the disclosure provided herein that many variations and modifications may be made to the embodiments described without departing from the scope of the present invention. All such modifications and variations are within the scope of the present invention.

What is claimed is:

1. A curing oven for curing a curable material that has been placed on an object disposed in the curing oven, the curing oven comprising:
a radiation source for emitting curing radiation; and
at least a first reflector that reflects curing radiation from the radiation source onto the object, the first reflector comprising a plurality of substantially flat reflective segments arranged in a curved configuration to form a reflective surface, the arrangement of the substantially flat reflective segments of the first reflector causing the curing radiation reflected thereby onto the object to be substantially uniformly distributed over at least a portion of the object, thereby substantially uniformly curing the curable material on said portion of the object.

2. The curing oven of claim 1, further comprising:
a second reflector that reflects curing radiation from the radiation source onto the object, the second reflector comprising a plurality of substantially flat reflective segments arranged in a curved configuration to form a reflective surface, the arrangement of the substantially flat reflective segments of the second reflector causing the curing radiation reflected by the second reflector to be substantially uniformly distributed over at least a portion of the object, thereby substantially uniformly curing the curable material on said portion of the object, and wherein the reflective surfaces of the first and second reflectors face one another.

3. The curing oven of claim 1, wherein the first reflector is positioned below the radiation source and wherein the reflective surface of the first reflector faces the radiation source and the object, the object being disposed in the curing oven between the radiation source and the first reflector.

4. The curing oven of claim 1, wherein the reflective segments of the first reflector are arranged in a generally parabolic configuration.

5. The curing oven of claim 1, further comprising:
a second reflector that reflects curing radiation from the radiation source onto the object, the second reflector having a reflective surface, and wherein the reflective surfaces of the first and second reflectors face one another, the second reflector being positioned above the radiation source and facing the radiation source and the object, the first reflector being positioned below the radiation source and facing the radiation source and the object, the object being disposed between the radiation source and the first reflector, and wherein the reflective surface of the second reflector comprises a plurality of substantially flat reflective segments arranged in a curved configuration, the arrangements of the reflective segments of the first and second reflectors causing the curing radiation reflected by the first and second reflective curved surfaces onto the object to be substantially uniformly distributed over at least a portion of the object, thereby substantially uniformly curing the curable material on said portion of the object.

6. The curing oven of claim 5, wherein the configuration of the reflective segments of the first reflector is generally parabolic in shape.

7. The curing oven of claim 1, wherein the curing oven is an ultraviolet (UV) radiation curing oven, the curable material being cured when the curable material is exposed to a sufficient amount of UV radiation, the radiation source emitting UV radiation.

8. The curing oven of claim 1, wherein the object is an optical fiber ribbon.

9. A reflector for a curing oven, the curing oven causing a curable material that has been placed on an object disposed in the curing oven to be cured, the curing oven including a radiation source that emits a curing radiation to which the curable material reacts, the reflector comprising:
a plurality of substantially flat reflective segments arranged in a curved configuration, the arrangement of the reflective segments causing the curing radiation emitted by the radiation source and reflected by the reflective surface onto the object to be substantially uniformly distributed over at least a portion of the object to substantially uniformly cure the curable material on said portion of the object.

10. The reflector of claim 9, wherein the curved configuration of the reflective segments is generally parabolic in shape.

11. The reflector of claim 9, wherein the curing oven is an ultraviolet (UV) radiation curing oven, the curable material being cured when the curable material is exposed to a sufficient amount of UV radiation, the radiation source emitting UV radiation.

12. The reflector of claim 11, wherein the object is an optical fiber ribbon that is being pulled through the UV curing oven, the curable material being a polymeric matrix material.

13. A method for curing a curable material that has been placed on an object disposed in a curing oven, the method comprising the steps of:
emitting curing radiation from a radiation source; and
providing a first reflector that reflects curing radiation emitted by the radiation source onto the object, the first reflector comprising a plurality of substantially flat reflective segments arranged in a curved configuration to form a reflective surface, the arrangement of the substantially flat reflective segments of the first reflector causing the curing radiation reflected by the first reflector to be substantially uniformly distributed over at least a portion of the object to substantially uniformly cure the curable material on said portion of the object.

14. The method of claim 13, further comprising the step of:
providing a second reflector that reflects curing radiation emitted by the radiation source onto the substantially flat object, the second reflector comprising a plurality of substantially flat reflective segments arranged to form a reflective surface of the second reflector, the arrangement of the substantially flat reflective segments of the second reflector causing the curing radiation reflected by the second reflector to be substantially uniformly distributed over at least a portion of the object, thereby substantially uniformly curing the curable material on the object.

15. The method of claim 13, wherein the first reflector is positioned below the radiation source and faces the radiation source and the object, the object being disposed in the curing oven between the radiation source and the first reflector.

16. The method of claim 13, wherein the configuration of the reflective segments of the first reflector is generally parabolic in shape.

17. The method of claim 14, wherein the configuration of the reflective segments of the second reflector is generally parabolic in shape.

18. The method of claim 13, wherein the curing oven is an ultraviolet (UV) radiation curing oven, the curable material being cured when the curable material is exposed to a sufficient amount of UV radiation, the radiation source emitting UV radiation.

19. The method of claim 13, wherein the object is an optical fiber ribbon.
